(19) United States
(12) Patent Application Publication
(10) Pub. No.: US 2025/0274474 A1
(43) Pub. Date: Aug. 28, 2025

(54) METHOD AND APPARATUS FOR GENERATING CYBERATTACK SEQUENCE BASED ON REINFORCEMENT LEARNING

(71) Applicant: Electronics and Telecommunications Research Institute, Daejeon (KR)

(72) Inventors: Ki-Jong KOO, Daejeon (KR); Dae-Sung MOON, Daejeon (KR); Jae-Hak YU, Daejeon (KR); Yang-Seo CHOI, Daejeon (KR)

(73) Assignee: Electronics and Telecommunications Research Institute, Daejeon (KR)

(21) Appl. No.: 18/999,274

(22) Filed: Dec. 23, 2024

(30) Foreign Application Priority Data
Feb. 23, 2024 (KR) 10-2024-0026345

(51) Int. Cl. H04L 9/40; G06N 20/00

(52) U.S. Cl. CPC H04L 63/1433; G06N 20/00; H04L 63/0209

(57) ABSTRACT

Disclosed herein is a method for generating a cyberattack sequence based on reinforcement learning. The method includes generating a cyberattack simulation environment, training a cyberattack agent model based on the cyberattack simulation environment, and generating an attack sequence using the trained cyberattack agent model.

### CROSS REFERENCE TO RELATED APPLICATION

This application claims the benefit of Korean Patent Application No. 10-2024-0026345, filed Feb. 23, 2024, which is hereby incorporated by reference in its entirety into this application.

### BACKGROUND OF THE INVENTION

### 1. Technical Field

The present disclosure relates to technology for generating a cyberattack sequence that can be applied to a real environment based on reinforcement learning.

More particularly, the present disclosure relates to technology for training a cyberattack agent in various penetration testing environments and generating a cyberattack sequence having high accuracy.

### 2. Description of the Related Art

As cyberattacks by hackers armed with Artificial Intelligence (AI) technology become more sophisticated and massive, the aspect of cyberwarfare is changing from traditional reactive methods (e.g., perimeter security, Endpoint Detection and Response (EDR), etc.), which detect cyberattacks and build a response system, to proactive methods (e.g., penetration testing), which remedy security vulnerabilities by assessing the security level of a target organization.

Currently, most of the proactive methods, which remedy security vulnerabilities by assessing the security level of a target organization, rely on the expertise of white hackers and expose limitations in penetration testing across the entire domain area and continuous security assessments. Meanwhile, according to “2021 National Information Security White Paper” published in South Korea, it is expected that there will be a shortage of about 10,000 information protection personnel by 2025 due to the widespread and continuously growing cyberthreats, so it is required to train cybersecurity professionals through multidisciplinary education customized for institutions, domestic companies, and the military by a national cyber response system.

All over the world, cyberwarfare training tools have been developed under the leadership of governments and are used to train and develop cybersecurity professionals. For example, there are National Cyber Range (NCR) developed by the Defense Advanced Research Projects Agency (DARPA) of United States, CyberGym of Israel, Cyber Range Instantiation System (CyRIS) developed by the Japan Advanced Institute of Science and Technology (JAIST) of Japan, and the like. In South Korea, there are the cyber security training center of the National Security Research Institute (NSR), Security-Gym of the Korea Internet & Security Agency (KISA), a training ground for a cyberattack defense competition, the cyberwarfare training ground of the Cyber Operations Command, cyber-training grounds of the Army, Navy, and Air Force, and the like. In order to maximize the training effect of these major cyber-training grounds, it is most important to secure various warfare scenarios.

The warfare scenarios of the existing cyber-training grounds have limitations in modeling complex settings (networks, security systems, virtual network emulators, etc.) of a real environment because a simulated attack (emulation) is performed by generating a random warfare scenario based on the knowledge of experts (white hackers) or securing an attack scenario based on breach incident cases, and thus there is a limitation in generating various warfare scenarios. As a result, it is easy for personnel training to end up at most at a basic level, and it is difficult to perform training to respond to up-to-date attacks.

In order to solve these problems, a customized cyber-training ground in which the purpose of training, the levels of trainees, and domain requirements are reflected is required, and it is necessary to generate various warfare scenarios that can make various attack/defense attempts across the actual complex network cyber-system. To this end, many researchers around the world are conducting research on autonomous penetration testing agents based on reinforcement learning. By defining penetration testing as a Markov Decision Process (MDP) problem and training an agent that performs the optimal attack for a given network environment, a cyberattack scenario (sequence or Course of Actions (CoAs)) is generated through the cyberattack agent based on reinforcement learning.

The technology for generating a cyberattack scenario based on reinforcement learning is categorized into emulation technology and simulation-based technology. The emulation technology virtualizes network and host environments by using virtualization technology and generates attack scenarios by applying attack techniques used by real human hackers. The emulation technology may raise the accuracy of attacks, but it is not practical because collecting data required for training a reinforcement learning agent is time-consuming. Meanwhile, most of the major simulation-based technologies, which are being actively researched, are developed by simplifying the state of environments (a network and a host) and abstracting actions (attack techniques). However, attack scenarios generated by cyberattack agents trained under this condition have a limitation in application to a real environment (network) due to the low simulation accuracy thereof.

In order to overcome the limitations of the cyberattack simulation technology described above, the present disclosure provides a method for generating a cyberattack sequence based on reinforcement learning such that it can be applied to a real environment by quickly training a cyberattack agent (model) based on reinforcement learning in various penetration testing environments and generating a cyberattack scenario (sequence) having high accuracy.

### Documents of Related Art

(Patent Document 1) Korean Patent No. 2167644, titled “Multi-level scenario authoring method for threat in cyber-training environment”.

### SUMMARY OF THE INVENTION

An object of the present disclosure is to generate a cyberattack sequence that can be applied to a real environment based on reinforcement learning.

Another object of the present disclosure is to train a cyberattack agent in various penetration testing environments and to generate a cyberattack sequence having high accuracy.

In order to accomplish the above objects, a method for generating a cyberattack sequence based on reinforcement learning according to an embodiment of the present disclosure includes generating a cyberattack simulation environment, training a cyberattack agent model based on the cyberattack simulation environment, and generating an attack sequence using the trained cyberattack agent model.

Here, the simulation environment may be configured with a network model, an action space, a state space, and a reward function.

Here, generating the cyberattack simulation environment may comprise generating the cyberattack simulation environment by receiving a predefined simulation scenario configuration file, and the simulation scenario configuration file may include network configuration information, host asset configuration information, and information about an attack technique.

Here, the network model may be configured with a subnetwork, topology, a host, and a firewall, and an allocation value used to calculate a reward value may be defined in the host.

Here, the action space may be configured with a pair of the host and the attack technique, and the attack technique may include pre-attack state information of the host and state information of the host in the event of a successful attack.

Here, the state space may be configured with the state of a host constituting a network and a result of execution of the attack technique.

Here, the reward function may be calculated based on the value of a compromised host depending on a change in the state space.

Here, training the cyberattack agent model may comprise generating a cyberattack sequence for the cyberattack simulation environment and performing training using a reward for a state for the generated cyberattack sequence.

Here, training the cyberattack agent model may comprise analyzing the generated cyberattack sequence and changing, when the state of a host satisfies pre-attack state information, the state to the state information of the host in the event of a successful attack.

Here, the attack technique may correspond to an attack technique of a MITRE ATT&CK framework.

Also, in order to accomplish the above objects, an apparatus for generating a cyberattack sequence based on reinforcement learning according to an embodiment of the present disclosure includes memory in which at least one program is recorded and a processor for executing the program. The program includes instructions for performing generating a cyberattack simulation environment, training a cyberattack agent model based on the cyberattack simulation environment, and generating an attack sequence using the trained cyberattack agent model.

Here, the simulation environment may be configured with a network model, an action space, a state space, and a reward function.

Here, generating the cyberattack simulation environment may comprise generating the cyberattack simulation environment by receiving a predefined simulation scenario configuration file, and the simulation scenario configuration file may include network configuration information, host asset configuration information, and information about an attack technique.

Here, the network model may be configured with a subnetwork, topology, a host, and a firewall, and an allocation value used to calculate a reward value may be defined in the host.

Here, the action space may be configured with a pair of the host and the attack technique, and the attack technique may include pre-attack state information of the host and state information of the host in the event of a successful attack.

Here, the state space may be configured with the state of a host constituting a network and a result of execution of the attack technique.

Here, the reward function may be calculated based on the value of a compromised host depending on a change in the state space.

Here, training the cyberattack agent model may comprise generating a cyberattack sequence for the cyberattack simulation environment and performing training using a reward for a state for the generated cyberattack sequence.

Here, training the cyberattack agent model may comprise analyzing the generated cyberattack sequence and changing, when the state of a host satisfies pre-attack state information, the state to the state information of the host in the event of a successful attack.

Here, the attack technique may correspond to an attack technique of a MITRE ATT&CK framework.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for generating a cyberattack sequence based on reinforcement learning according to an embodiment of the present disclosure;

FIG. 2 is a conceptual diagram illustrating a cyberattack simulation process based on reinforcement learning according to an embodiment of the present disclosure;

FIGS. 3 to 5 are examples of a simulation scenario configuration file;

FIG. 6 is an example of a network model according to an embodiment of the present disclosure;

FIG. 7 is an example of the definition of attack techniques according to an embodiment of the present disclosure;

FIGS. 8 to 11 are examples of an action space configured with attack techniques for each host;

FIG. 12 is an example of the definition of an attack technique including a pre-state and a post-state;

FIG. 13 is an example of a reinforcement learning environment state table;

FIG. 14 conceptually illustrates a cyberattack agent training model based on reinforcement learning;

FIG. 15 is an example of an attack sequence provided in a simulation scenario;

FIG. 16 illustrates a result of a state change according to a manual-based attack sequence;

FIG. 17 is an example of a Deep Q-Network (DQN) structure and training parameters;

FIG. 18 illustrates a result of training of a cyberattack agent that is trained using a DON reinforcement learning algorithm;

FIG. 19 is a conceptual diagram illustrating the procedure of configuring a simulation scenario and performing an attack; and

FIG. 20 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

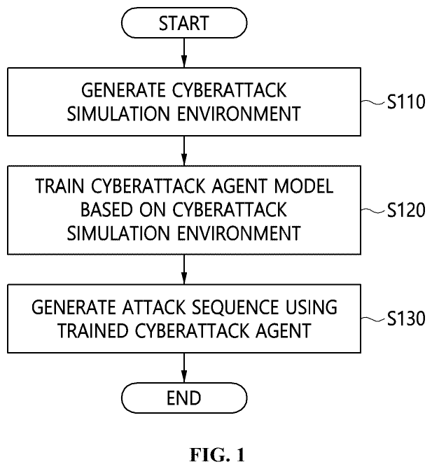

FIG. 1 is a flowchart illustrating a method for generating a cyberattack sequence based on reinforcement learning according to an embodiment of the present disclosure.

The method for generating a cyberattack sequence based on reinforcement learning according to an embodiment of the present disclosure may be performed by a cyberattack sequence generation apparatus such as a computing device, a server, or the like.

Referring to FIG. 1, the method for generating a cyberattack sequence based on reinforcement learning according to an embodiment of the present disclosure includes generating a cyberattack simulation environment at step S110, training a cyberattack agent model based on the cyberattack simulation environment at step S120, and generating an attack sequence using the trained cyberattack agent model at step S130.

Here, the simulation environment may be configured with a network model, an action space, a state space, and a reward function.

Here, generating the cyberattack simulation environment at step S110 may comprise generating the cyberattack simulation environment by receiving a predefined simulation scenario configuration file, and the simulation scenario configuration file may include network configuration information, host asset configuration information, and attack technique information.

Here, the network model may be configured with a subnetwork, topology, a host, and a firewall, and an allocation value used to calculate a reward value may be defined in the host.

Here, the action space may be configured with a pair of the host and the attack technique, and the attack technique may include the pre-attack state information of the host and the state information of the host in the event of a successful attack.

Here, the state space may be configured with the state of the host constituting a network and a result of execution of the attack technique.

Here, the reward function may be calculated based on the value of a compromised host depending on a change in the state space.

Here, training the cyberattack agent model at step S120 may comprise generating a cyberattack sequence for the cyberattack simulation environment and performing training using a reward for a state for the generated cyberattack sequence.

Here, training the cyberattack agent model at step S120 may comprise analyzing the generated cyberattack sequence and changing, when the state of the host satisfies the pre-attack state information, the state to the state information of the host in the event of a successful attack.

Here, the attack technique may correspond to the attack technique of the MITRE ATT&CK framework.

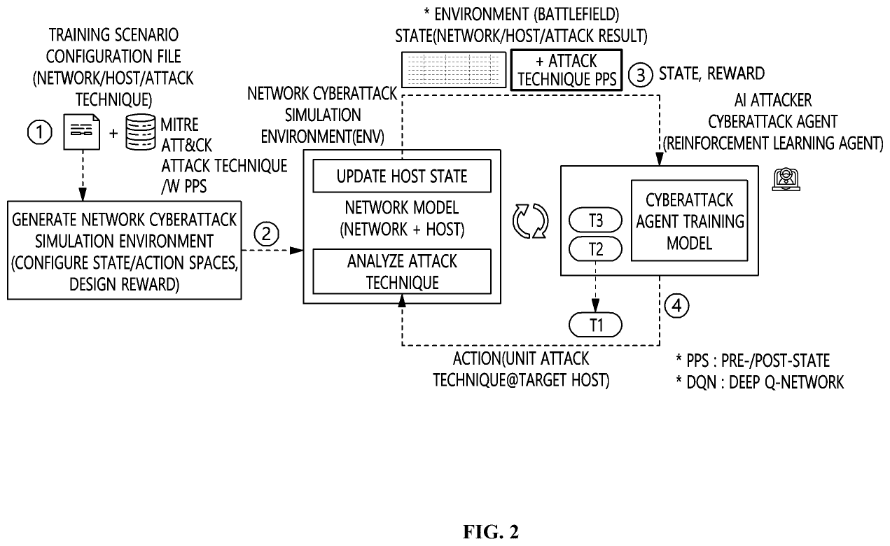

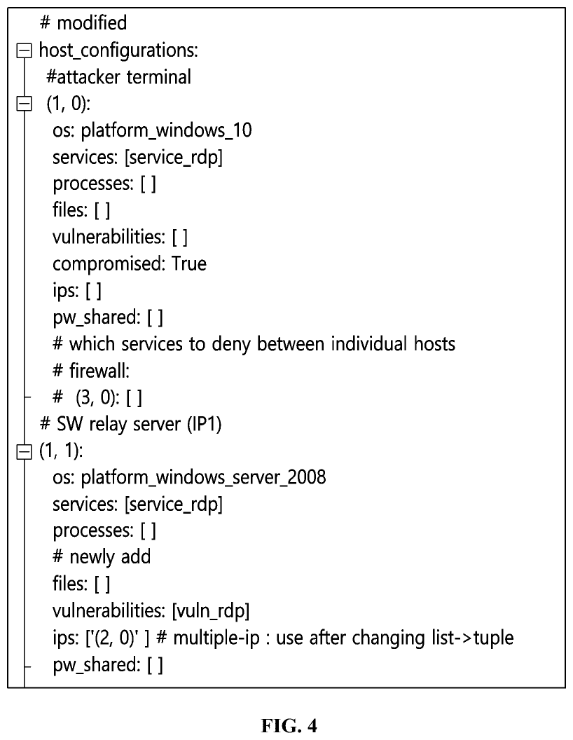

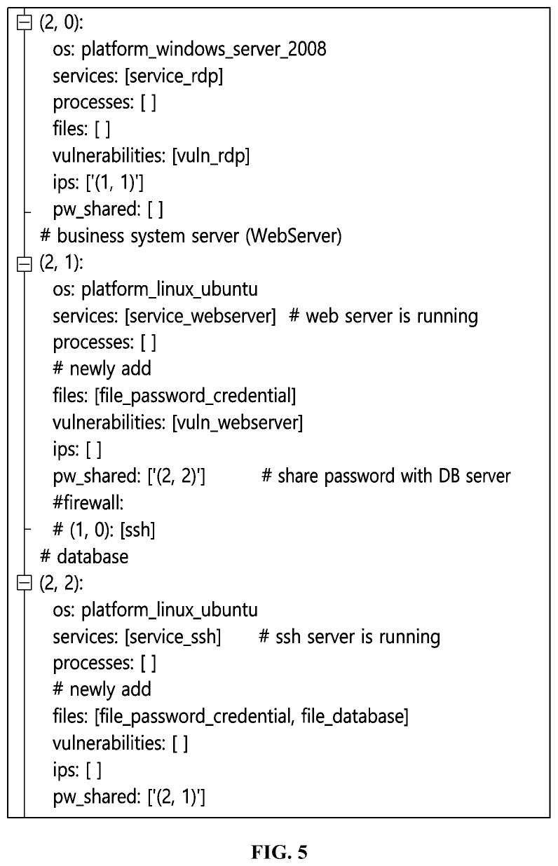

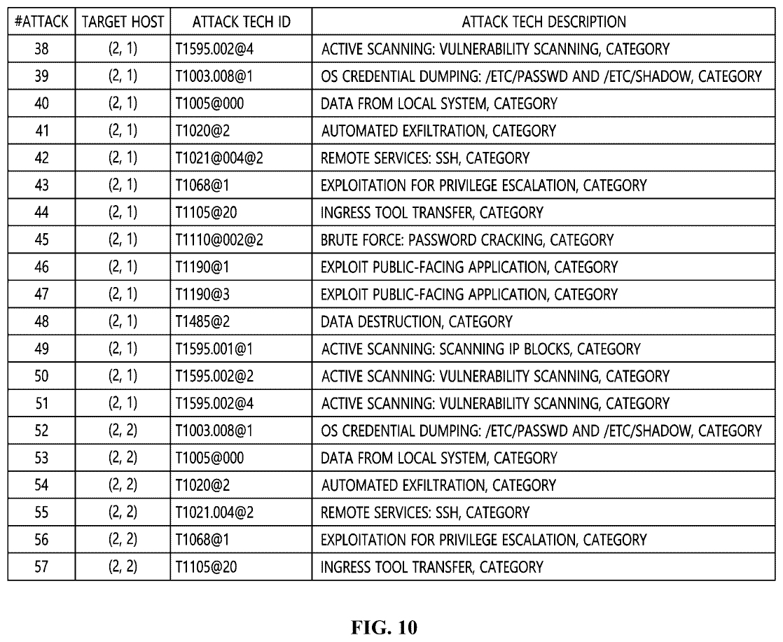

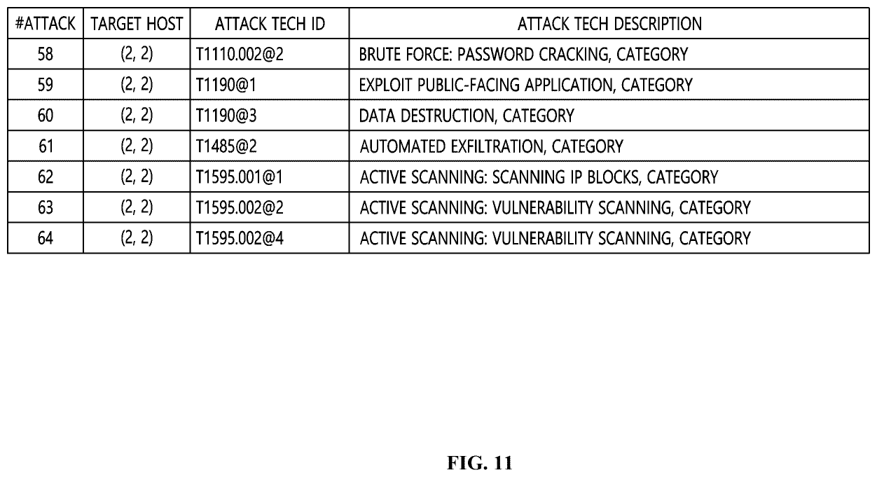

Hereinafter, an embodiment of the present disclosure will be described in more detail with reference to FIGS. 2 to 14.

The method for generating a cyberattack sequence based on reinforcement learning according to an embodiment of the present disclosure may include generating a cyberattack simulation environment, modeling (generating/training) a cyberattack agent, and generating a cyberattack sequence.

Here, generating the cyberattack simulation environment may include loading a simulation scenario configuration file and generating a network cyberattack simulation environment. Also, generating the cyberattack sequence may include generating (or initializing) an attack environment, loading the trained cyberattack agent training model, and generating the attack sequence.

FIG. 2 is a conceptual diagram illustrating a cyberattack simulation process based on reinforcement learning according to an embodiment of the present disclosure.

Generating the network cyberattack simulation environment may comprise generating the network cyberattack simulation environment required for training of a cyberattack agent by receiving a predesigned simulation scenario configuration file. The network cyberattack simulation environment may be configured with a network model, an action space, a state space, and a reward function.

The simulation scenario configuration file may include configuration information of a network (a subnetwork, topology, a firewall, etc.), configuration information of host assets (an OS, a service, a vulnerability, a file, etc.), MITRE ATT&CK attack technique information in which a pre-state and a post-state are defined, and the like.

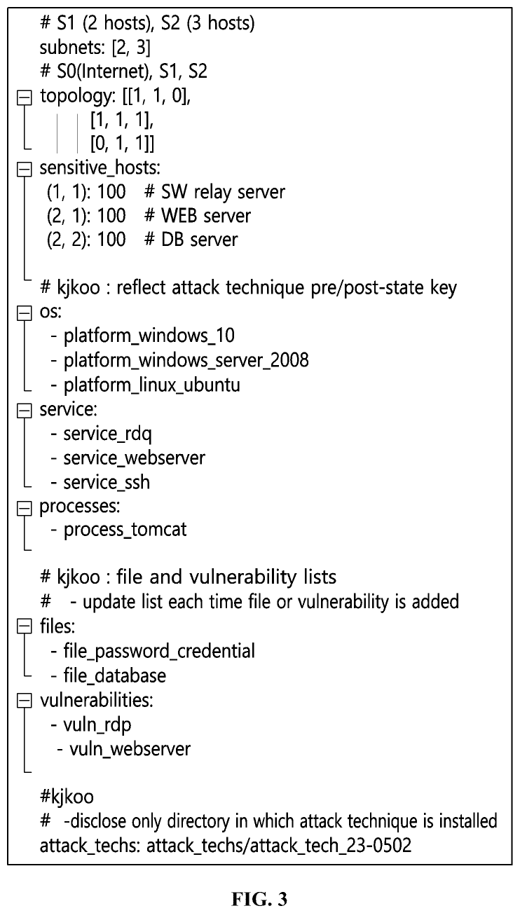

FIGS. 3 to 5 are examples of a simulation scenario configuration file.

A network model may be configured with subnetworks (subnets), topology, hosts, and firewalls. Here, the subnet may index subnets and hosts in a simple subnet address format. For example, (2, 0) indicates the first system of subnet 2. All of the systems in a subnet may communicate with each other, but communication between subnets is controlled by the topology and firewall settings.

The topology may define a connection to an external network as well as a connection between subnets. The host may be configured with an operating system (OS) run on the host, a service, user authority, a vulnerability, and a file as well as the address. Each host may run an OS and one or more services. The host may have a value allocated thereto. The target host of a cyberattack agent may be allocated a higher value. This value may be used to calculate a reward for an action. The firewall may define which communication between subnets is allowed or prohibited.

FIG. 6 is an example of a network model according to an embodiment of the present disclosure.

Table 1 below is an example of host asset configuration information.

TABLE 1

| Host | Host Asset configuration |
|---|---|
| attacker | Platform_Window_10, Service_RDP, Authority(0 = |
| terminal | USER) |
| SW relay | Platform_Windows_Server_2008, Service_RDP, Vuln_{—} |
| server | RDP, Authority(0 = USER) |
| business | Platform_Linux_Ubuntu, Service_webServer, Vuln_{—} |
| system | Webserver, FILE_password_Credential, Authority(0 = |
| server | USER) |
| database | Platform_Linux_Ubuntu, Service_SSH, FILE_password_{—} |
| | Credential, Authority(0 = USER), FILE_database |

The action space may be configured with pairs of hosts constituting the network model and attack techniques. Here, attack techniques basically provided by the MITRE ATT&CK framework may be used for the attack techniques.

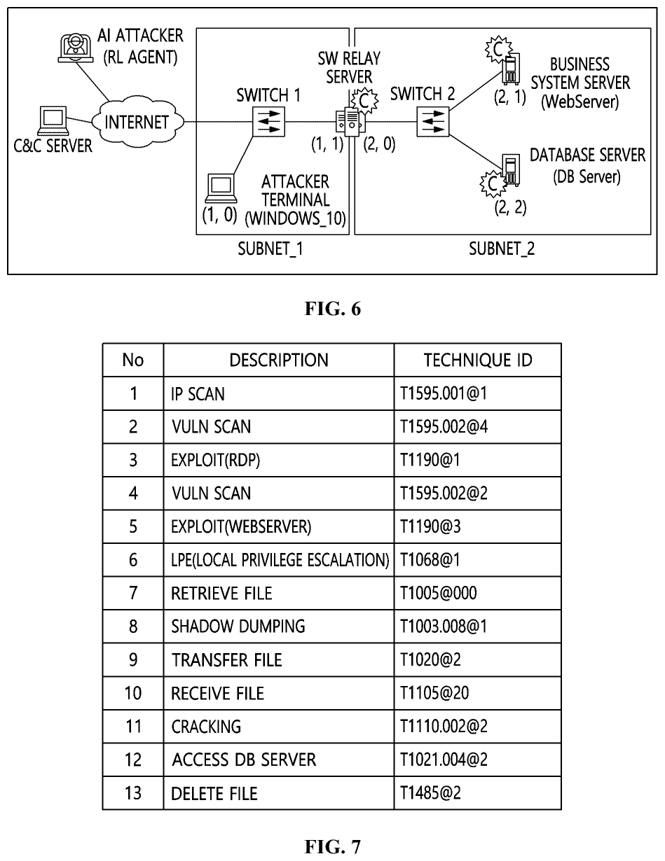

FIG. 7 is an example of the definition of attack techniques according to an embodiment of the present disclosure.

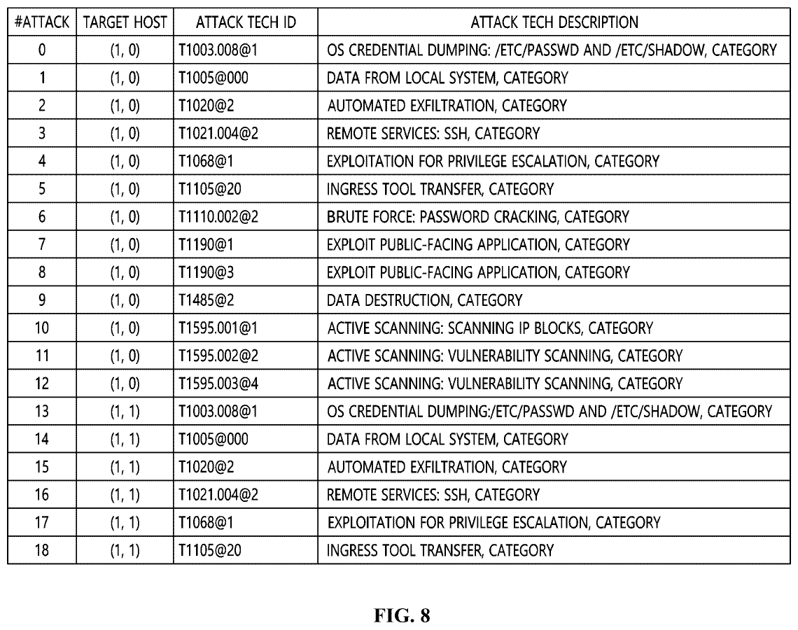

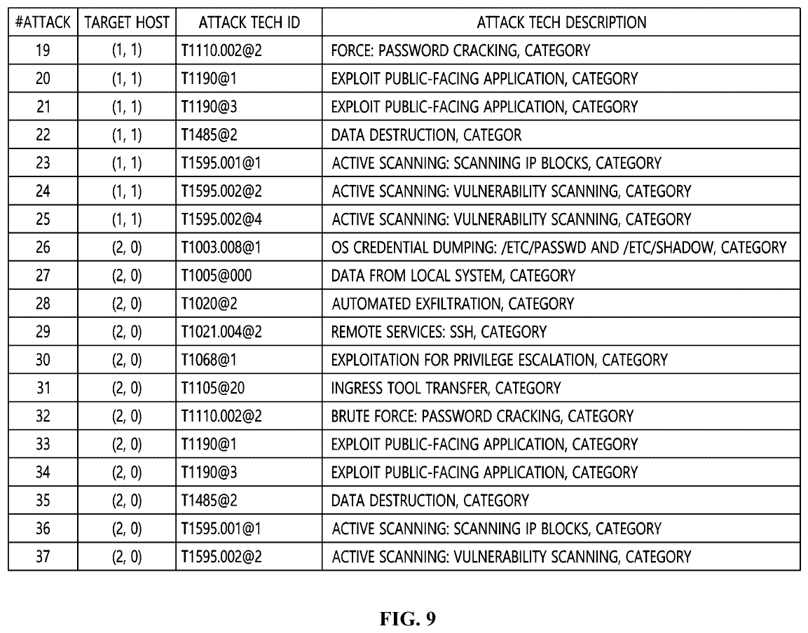

FIGS. 8 to 11 are examples of an action space including attack techniques for each host.

Here, pre-state and post-state features are additionally defined and added to the attack technique for application to a real environment. Here, the pre-state is the state of the target host for an attack technique to be successful, and the post-state may correspond to the state of the target host changed when the attack technique is successfully performed.

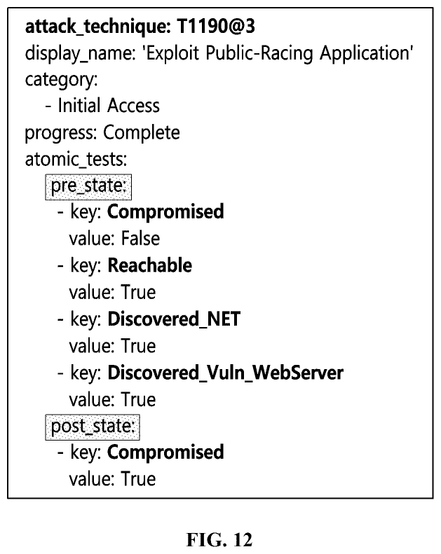

FIG. 12 is an example of the definition of an attack technique including pre-state and post-state features.

Referring to FIG. 12, the type and feature value of each of the pre-state and post-state features may be defined as a key and a value, respectively, in an attack technique. Using an example of a network model, the types (keys) of the pre-state and post-state features may be defined as follows. Here, true/false, 0/1/2, or the like may be assigned as the values of the features.
Compromised: dominated
Reachable: connected to a network
Discovered_Net: discovered in a network
Discovered_Vuln_webServer: a web vulnerability is discovered
Discovered_Vuln_RDP: an RDP vulnerability is discovered
Discovered_Service_RDP: it is discovered that an RDP service is running
Discovered_Service_WebServer: it is discovered that a Web server is running
Discovered_Service_SSH: it is discovered that SSH is running
Discovered_FILE_database: a database file is discovered
Discovered_FILE_password_Credential: a password file is discovered
platform_(linux_ubuntu/windows_10/windows_server_2008): The operating system being used in a host
Authority: permission
Dumped_password_Credential: a password dump file
Cracked_password_Credential: a password cracked file
leaked: leaked
destroyed: deleted
recv_file_st: a file is received

The state space may be configured with the states of all of the hosts constituting the network and the results of execution of the attack techniques. The state of each of the hosts may be configured with a set of pre-state and post-state features defined for all attack techniques. An example of a feature set is as follows.

(‘Compromised’, ‘Reachable’, ‘Discovered’, ‘authority’, ‘cracked_password_credential’, ‘destroyed’, ‘discovered_file_database’, ‘discovered_file_password_credential’, ‘discovered_net’, ‘discovered_service_rdp’, ‘discovered_service_ssh’, ‘discovered_service_webserver’, ‘discovered_vuln_rdp’, ‘discovered_vuln_webserver’, ‘dumped_password_credential’, ‘leaked’, ‘platform_linux_ubuntu’, ‘platform_windows_10’, ‘platform_windows_server_2008’, ‘recv_file_st’)

Also, the state space may include a host address and a host allocation value. Also, the state space may include an observation vector for checking whether an attack technique is successful. The observation vector may include a feature indicating whether an attack is successful (success) and connection/permission/undefined error features.

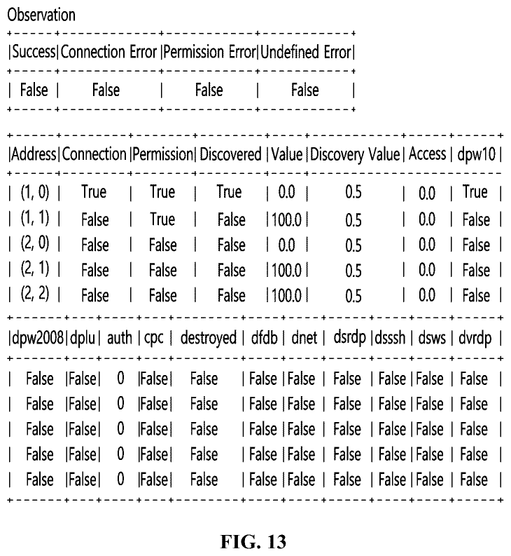

FIG. 13 is an example of a reinforcement learning environment state table.

Referring to FIG. 13, the reinforcement learning environment (cyber-battlefield) state table using the pre/post-states of an attack technique may include multiple fields for representing the state information of a host, and the definition of each field expressed with the abbreviation therefor is as follows:

{‘platform_windows_10’: ‘dpw10’, ‘platform_windows_server_2008’: ‘dpws2008’, ‘platform_linux_ubuntu’: ‘dplu’, ‘service_rdp’: ‘srdp’, ‘service_webserver’: ‘sws’, ‘service_ssh’: ‘sssh’, ‘process_tomcat’: ‘ptom’, ‘authority’: ‘auth’, ‘cracked_password_credential’: ‘cpc’, ‘destroyed’: ‘destroyed’, ‘discovered_file_database’: ‘dfdb’, ‘discovered_file_password_credential’: ‘dfpc’, ‘discovered_net’: ‘dnet’, ‘discovered_service_rdp’: ‘dsrdp’, ‘discovered_service_ssh’: ‘dsssh’, ‘discovered_service_webserver’: ‘dsws’, ‘discovered_vuln_rdp’: ‘dvrdp’, ‘discovered_vuln_webserver’: ‘dvws’, ‘dumped_password_credential’: ‘dmpc’, ‘leaked’: ‘leaked’, ‘recv_file_st’: ‘rfst’}

In the method according to an embodiment of the present disclosure, a reward function may be defined for transition R (St+1, at, St) as shown in Equation (1) below:

$$R ( {s}_{t + 1} , {a}_{t} , {s}_{t} ) = value ( {s}_{t + 1} , {s}_{t} ) - cost ( {a}_{t} ) \qquad ( 1 )$$

In Equation (1), value (St+1, St) may return the value of a newly compromised host during the transition from st to st+1 when an action (attack technique) is performed with cost (at). For example, when the default cost (at) is 1 (cost (at)=1) and when value (St+1, St) returns 0 (value (St+1, St)=0), the reward for the action is R (St+1, at, St)=−1. Modeling (generating/training) the cyberattack agent comprises training the cyberattack agent based on reinforcement learning to determine the optimal attack technique (action) for the network cyberattack simulation environment generated based on the cyberattack simulation scenario (yaml) by receiving environment state information. Once the training is completed, whether a cyberattack scenario (sequence) for achieving the objectives of the training scenario is generated is evaluated. After the evaluation is completed, the cyberattack agent model may be stored.

The cyberattack agent is trained using reinforcement learning algorithms and technology. Reinforcement learning is configured with an agent and an environment, and the agent determines an action depending on the state of the environment, updates the state of the environment by applying the determined action to the environment, and receives an appropriate reward therefor. The same process is repeatedly performed until the training objective of the agent is reached.

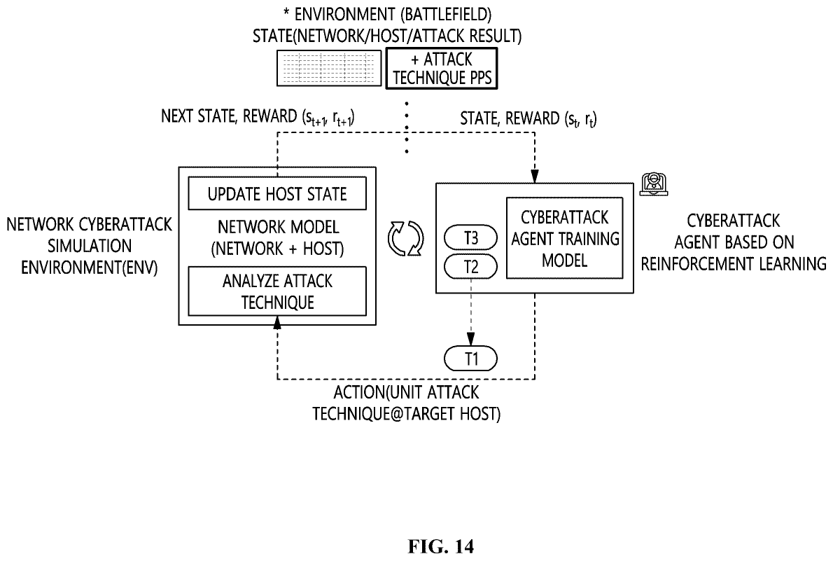

FIG. 14 conceptually illustrates a cyberattack agent training model based on reinforcement learning.

When a cyberattack agent is trained, a step and an episode may be defined. A single step is configured with a process in which the agent determines an action depending on the state of an environment, updates the state of the environment by applying the determined action to the environment, and receives an appropriate reward therefor. A single episode starts with the initial state of the environment and repeatedly performs the step until the objective defined in a simulation scenario is achieved. When the objective is achieved, the episode ends. Also, when the objective is not achieved by a preset step_limit, the episode ends.

As an embodiment of cyberattack agent modeling, a simulation scenario for training a cyberattack agent based on reinforcement learning is designed. A network cyberattack simulation environment is generated based on the simulation scenario. Subsequently, the cyberattack agent based on reinforcement learning is trained so as to determine the optimal action (a target host and an attack technique) for the network cyberattack simulation environment by receiving environment state information. The cyberattack agent is trained by repeating the episode until it is determined that training of the model is completed such that the model can determine the optimal action depending on the state of the environment. After training the cyberattack agent is completed, the generated attack sequence is evaluated by comparing the same with a manual-based attack sequence. Here, in order to evaluate the result of training of the cyberattack agent based on reinforcement learning, the manual-based attack sequence is generated by a manual-(user-) based attack agent in the same environment before the cyberattack agent to which a reinforcement learning algorithm is applied is trained. After the evaluation is completed, the cyberattack agent model is stored. As the reinforcement learning algorithm used for the cyberattack agent training model, Q-Learning, Deep Q-Learning, Advantage Actor Critic (A2C), Proximal Policy Optimization (PPO), and the like may be used.

The network cyberattack simulation environment analyzes the target host and the attack technique upon receiving the action of the cyberattack agent and updates the state of the host to the post-state value defined in the attack technique if the state of the host satisfies the pre-state condition of the attack technique when the attack technique is applied to the target host. If the state of the target host satisfies the pre-state of the attack technique, it is determined that the attack technique is successful, and the success feature of an observation vector is set to true. However, if the state of the target host does not satisfy the pre-state of the attack technique, the success feature is set to false, and the feature related thereto, among the error features (connection/permission/undefined) of the observation vector, is set to true.

The simulation scenario aims to find a host and a service in a network, exploit the vulnerabilities of the corresponding host service, and compromise three types of target hosts (a software relay server, a business system server, and a DB server) by using (13 types of) MITRE ATT&CK attack techniques in which pre-state and post-state features are defined for the network cyberattack simulation environment in the example of the network model corresponding to Table 1.

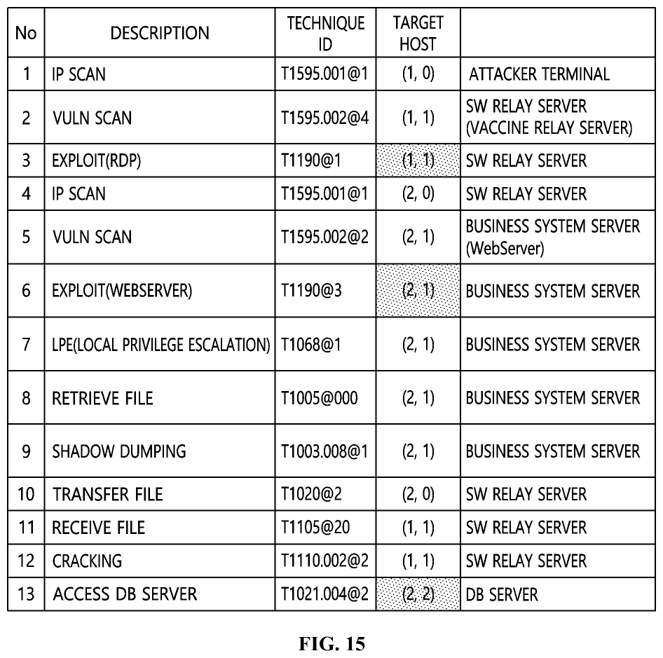

FIG. 15 is an example of an attack sequence provided in a simulation scenario.

A manual-based attack sequence enables a user to generate an attack sequence by referring to an environment state table and a list of actions (attack techniques) and directly selecting actions.

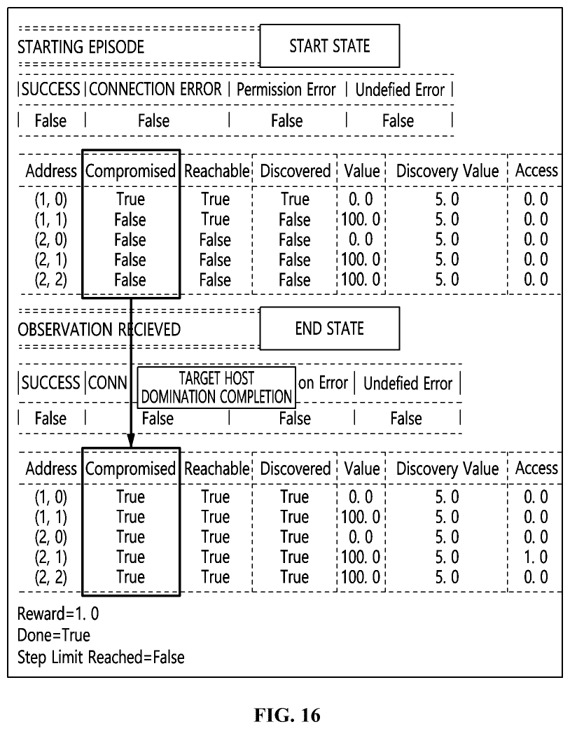

FIG. 16 illustrates a result of a change in a state according to a manual-based attack sequence.

Referring to FIG. 16, it can be seen that the compromised field is changed from ‘False’ to ‘True’ and a target host is compromised, and the result of execution of a manual agent can be seen.

The manual-based attack sequence may be represented using the index number of an action space including attack techniques for each host, illustrated in FIGS. 8A to 8D, and an example is as follows:
manual: [23, 25, 20, 49, 50, 47, 43, 40, 39, 28, 18, 19, 55] (13-steps: answer)

Subsequently, a cyberattack agent based on reinforcement learning (deep Q-learning) is trained. As an embodiment, a reinforcement learning algorithm may use a deep Q-Network (DQN).

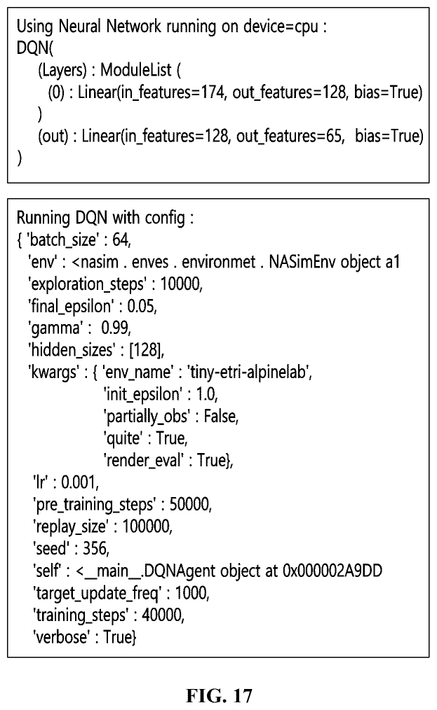

FIG. 17 is an example of a DQN network structure and training parameters.

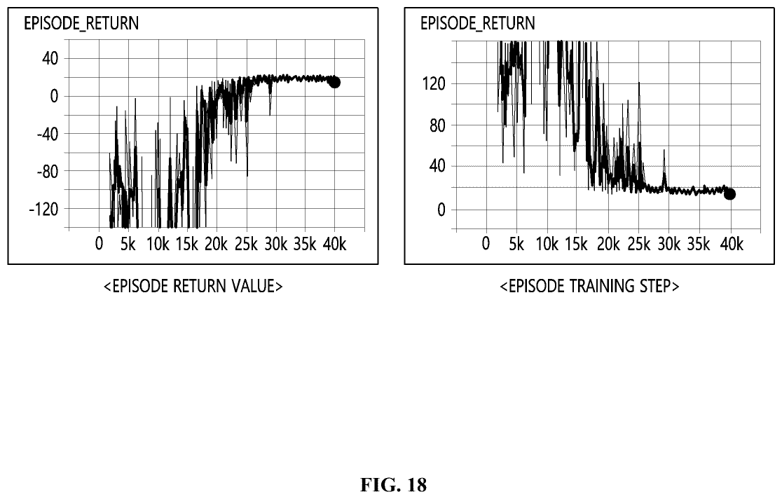

FIG. 18 illustrates a result of training a cyberattack agent, which is trained using a DON reinforcement learning algorithm.

A return value of each episode converges to a maximum value of 20 around the time at which the training step (training_step) exceeds 25k. Also, the number of training steps (training_steps) of each episode converges to a minimum of 16 around the time at which the training step exceeds 25k.

After training the cyberattack agent is completed, the generated attack sequence is evaluated by comparing the same with a manual-based attack sequence.

After DQN convergence, the result of the episode may be as follows. After the evaluation is completed, the structure and parameters corresponding to the cyberattack agent training model may be stored.
Attack sequence: 16 steps (similar to manual sequence)
episode return: 20 (maximum)
goal: achieved (three hosts are compromised)
training steps: 40,000

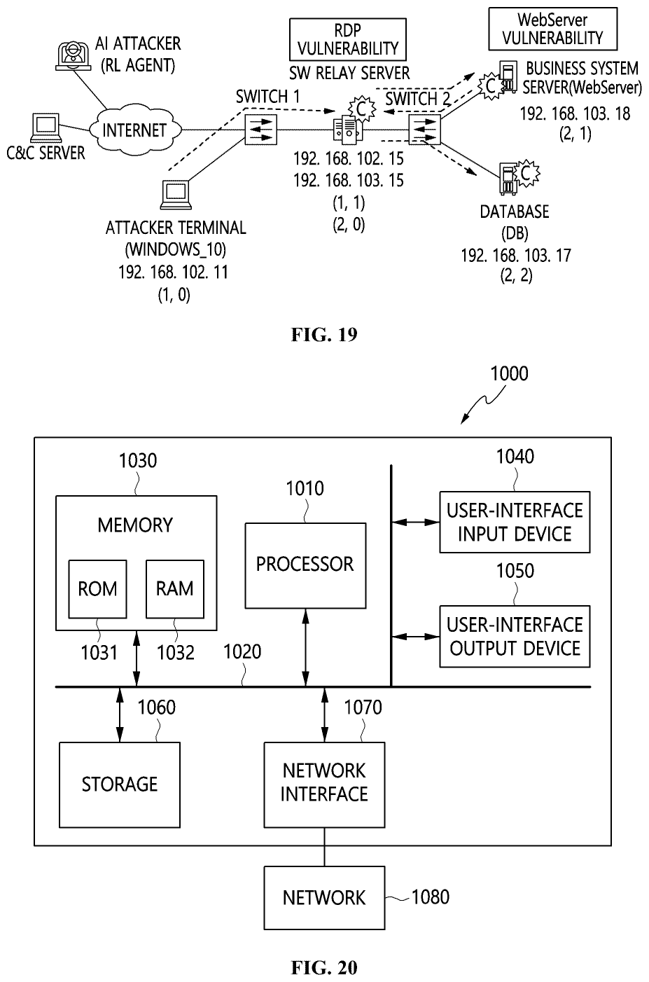

FIG. 19 is a conceptual diagram illustrating a procedure of configuring a simulation scenario and performing an attack.

Generating a cyberattack sequence comprises loading a pretrained cyberattack agent training model and generating an attack sequence configured with attack techniques for achieving the objective of a simulation scenario for the network cyberattack simulation environment of the simulation scenario.

As an embodiment for generating the cyberattack sequence, after a pretrained cyberattack agent training model is loaded, a cyberattack agent automatically generates an attack sequence configured with modified MITRE ATT&CK attack techniques for an initialized network cyberattack simulation environment.

FIG. 20 is a view illustrating the configuration of a computer system according to an embodiment.

The apparatus for generating a cyberattack sequence based on reinforcement learning according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

The apparatus for generating a cyberattack sequence based on reinforcement learning according to an embodiment of the present disclosure includes memory in which at least one program is recorded and a processor for executing the program, and the program includes instructions for performing generating a cyberattack simulation environment, training a cyberattack agent model based on the cyberattack simulation environment, and generating an attack sequence using the trained cyberattack agent model.

Here, the simulation environment may be configured with a network model, an action space, a state space, and a reward function.

Here, generating the cyberattack simulation environment may comprise generating the cyberattack simulation environment by receiving a predefined simulation scenario configuration file, and the simulation scenario configuration file may include network configuration information, host asset configuration information, and attack technique information.

Here, the network model may be configured with a subnetwork, topology, a host, and a firewall, and an allocation value used to calculate a reward value may be defined in the host.

Here, the action space may be configured with a pair of the host and the attack technique, and the attack technique may include pre-attack state information of the host and state information of the host in the event of a successful attack.

Here, the state space may be configured with the state of the host that constitutes the network and a result of execution of the attack technique.

Here, the reward function may be calculated based on the value of the compromised host depending on a change in the state space.

Here, training the cyberattack agent model may comprise generating a cyberattack sequence for the cyberattack simulation environment and performing training using a reward for the state for the generated cyberattack sequence.

Here, training the cyberattack agent model may comprise analyzing the generated cyberattack sequence and changing, when the state of the host satisfies the pre-attack state information, the state to the state information of the host in the event of a successful attack.

Here, the attack technique may correspond to the attack technique of the MITRE ATT&CK framework.

Using AI-based cyberwarfare simulation technology, analysis of vulnerabilities in major national infrastructure (energy, transportation, manufacturing, and the like) and evaluation of cyberattack response strategies may be performed, so this technology may be used to secure cybersecurity for the major national infrastructure and may have the effect of preventing large-scale damage that can economically and socially occur in the event of a cyberattack.

Also, the AI-based cyberwarfare simulation technology may be used as a cyber-attack/defense training platform for training cybersecurity personnel in order to strengthen cyberwarfare response capabilities. For example, in order to overcome limitations in providing passive training scenarios in major cyber-training grounds, a cyberwarfare scenario customized for the purpose of training is generated and provided using AI technology, whereby it is possible to train highly skilled cybersecurity personnel.

Also, an AI-based cyber-attack/defense scenario may be used for security consulting for the Information and Communication technologies (ICT) infrastructures of private and public institutions and may be used as a tool for evaluation/verification of functions/performance of a security solution installed in a target domain.

According to the present disclosure, a cyberattack sequence that can be applied to a real environment may be generated based on reinforcement learning.

Also, the present disclosure may train a cyberattack agent in various penetration testing environments and generate a cyberattack sequence having high accuracy.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for generating a cyberattack sequence based on reinforcement learning, comprising:
generating a cyberattack simulation environment;
training a cyberattack agent model based on the cyberattack simulation environment; and
generating an attack sequence using the trained cyberattack agent model.

2. The method of claim 1, wherein the simulation environment is configured with a network model, an action space, a state space, and a reward function.

3. The method of claim 2, wherein
generating the cyberattack simulation environment comprises generating the cyberattack simulation environment by receiving a predefined simulation scenario configuration file, and
the simulation scenario configuration file includes network configuration information, host asset configuration information, and information about an attack technique.

4. The method of claim 2, wherein
the network model is configured with a subnetwork, topology, a host, and a firewall, and
an allocation value used to calculate a reward value is defined in the host.

5. The method of claim 2, wherein
the action space is configured with a pair of a host and an attack technique, and
the attack technique includes pre-attack state information of the host and state information of the host in an event of a successful attack.

6. The method of claim 2, wherein the state space is configured with a state of a host constituting a network and a result of execution of an attack technique.

7. The method of claim 2, wherein the reward function is calculated based on a value of a compromised host depending on a change in the state space.

8. The method of claim 1, wherein training the cyberattack agent model comprises generating a cyberattack sequence for the cyberattack simulation environment and performing training using a reward for a state for the generated cyberattack sequence.

9. The method of claim 8, wherein training the cyberattack agent model comprises analyzing the generated cyberattack sequence and changing, when a state of a host satisfies pre-attack state information, the state to state information of the host in an event of a successful attack.

10. The method of claim 3, wherein the attack technique corresponds to an attack technique of a MITRE ATT&CK framework.

11. An apparatus for generating a cyberattack sequence based on reinforcement learning, comprising:
memory in which at least one program is recorded; and
a processor for executing the program,
wherein the program includes instructions for performing generating a cyberattack simulation environment,
training a cyberattack agent model based on the cyberattack simulation environment, and
generating an attack sequence using the trained cyberattack agent model.

12. The apparatus of claim 11, wherein the simulation environment is configured with a network model, an action space, a state space, and a reward function.

13. The apparatus of claim 12, wherein
generating the cyberattack simulation environment comprises generating the cyberattack simulation environment by receiving a predefined simulation scenario configuration file, and
the simulation scenario configuration file includes network configuration information, host asset configuration information, and information about an attack technique.

14. The apparatus of claim 12, wherein
the network model is configured with a subnetwork, topology, a host, and a firewall, and
an allocation value used to calculate a reward value is defined in the host.

15. The apparatus of claim 12, wherein
the action space is configured with a pair of a host and an attack technique, and
the attack technique includes pre-attack state information of the host and state information of the host in an event of a successful attack.

16. The apparatus of claim 12, wherein the state space is configured with a state of a host constituting a network and a result of execution of an attack technique.

17. The apparatus of claim 12, wherein the reward function is calculated based on a value of a compromised host depending on a change in the state space.

18. The apparatus of claim 11, wherein training the cyberattack agent model comprises generating a cyberattack sequence for the cyberattack simulation environment and performing training using a reward for a state for the generated cyberattack sequence.

19. The apparatus of claim 18, wherein training the cyberattack agent model comprises analyzing the generated cyberattack sequence and changing, when a state of a host satisfies pre-attack state information, the state to state information of the host in an event of a successful attack.

20. The apparatus of claim 13, wherein the attack technique corresponds to an attack technique of a MITRE ATT&CK framework.
